(19) United States
(12) Patent Application Publication
(10) Pub. No.: US 2015/0378701 A1
(43) Pub. Date: Dec. 31, 2015

(54) CROSS-ENVIRONMENT ORCHESTRATION OF DEPLOYMENT ACTIVITIES

(71) Applicant: Microsoft Corporation, Redmond, WA (US)

(72) Inventors: Jianfeng Cai, Redmond, WA (US); Shobana Krishnamoorthy, Redmond, WA (US); Peter Harwood, Seattle, WA (US); David Retterath, Kirkland, WA (US); Brad Smith, Seattle, WA (US); Roshane Silva, Seattle, WA (US)

(21) Appl. No.: 14/316,746

(22) Filed: Jun. 26, 2014

(51) Int. Cl. G06F 9/445

(52) U.S. Cl. CPC G06F 8/60; G06F 8/65

(57) ABSTRACT

Deployment of builds of upgrade, patches, and the like may be orchestrated using tables that reside outside the scope of any one environment, but that is accessible by the environments. The tables may define the activities that are pending or running in the system, as well as the dependency chains that prevent activities happening out of safe order (for example, a deployment happening on paying customers before happening in test environments). When a new build is available for deployment, it may be detected and new activities for that build listed as pending in the affected environments. Any activities having no prerequisite dependencies may start immediately, while those with prerequisites may wait for the prerequisite activities to be completed. The encoding of dependencies between activities and across environments may enable access to those from any deployment environment.

### BACKGROUND

Hosted services such as productivity applications, collaboration services, social and professional networking services, and similar ones are not only becoming increasingly popular, but also replacing individually installed local applications. Such services may vary from small size (a few hundred users) to very large (tens, possibly hundreds of thousands of users). Thus, deployment of software upgrades, patches, etc. is a concern for designers and providers of hosted services.

Conventional deployment activities may involve human staff in environment after environment, which may be inefficient and vulnerable to costly errors. Multiple handoffs between people may result in eventual breakdowns in communication. These issues may lead to inefficiency, as it may take longer for critical fixes to reach customers. Furthermore, human errors in deployment may result in server farm downtime, which may lead to significant user experience degradation.

### SUMMARY

According to some example implementations, a method to automate a flow of deployment activities across environments may include detecting receipt of a build from an external data source to a data store coupled to one or more servers and generating one or more dependency chains for deploying the received build to one or more environments. The method may further include utilizing one or more orchestrators executed at the one or more servers to perform the deployment activities in the one or more environments according to the one or more dependency chains.

### BRIEF DESCRIPTION OF THE DRAWINGS

FIG. 1 illustrates an example topology for a hosted service;

FIG. 2 illustrates example processes to deploy a build across environments;

FIG. 3 illustrates example processes to deploy a build across environments managed by an orchestrator;

FIG. 4 illustrates a multi-environment hosted service system, where deployment of builds may be managed by a central orchestrator;

FIG. 5 illustrates another multi-environment hosted service system, where deployment of builds may be managed by distributed orchestrators whose activities are coordinated by a central orchestrator;

FIG. 6 illustrates a further multi-environment hosted service system, where deployment of builds may be managed by distributed orchestrators;

FIG. 7 is a networked environment, where a system according to embodiments may be implemented;

FIG. 8 is a block diagram of an example computing operating environment, where embodiments may be implemented; and

FIG. 9 illustrates a logic flow diagram for a process of deploying a build across environments, according to embodiments.

### DETAILED DESCRIPTION

According to exemplary implementations, deployment of builds of upgrade, patches, and the like may be orchestrated using tables that reside outside the scope of any one environment, but that is accessible by the environments. The tables may define the activities that are pending or running in the system, as well as the dependency chains that prevent activities happening out of safe order (for example, a deployment happening on paying customers before happening in test environments). When a new build is available for deployment, it may be detected and new activities for that build listed as pending in the affected environments. Any activities having no prerequisite dependencies may start immediately, while those with prerequisites may wait for the prerequisite activities to be completed. The encoding of dependencies between activities and across environments may enable access to those from any deployment environment.

These and other features and advantages will be apparent from a reading of the following detailed description and a review of the associated drawings. In the following detailed description, references are made to the accompanying drawings that form a part hereof, and in which are shown by way of illustrations specific implementations or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

A “build” as used herein refers to any application, module, or combinations of applications and modules that are to be distributed to a number of computers and computing systems in one or more environments. For example, a build may refer to a first version of an application, a patch for an already installed application, a subsequent version of an installed application that is intended to replace an already installed version of the same application, etc.

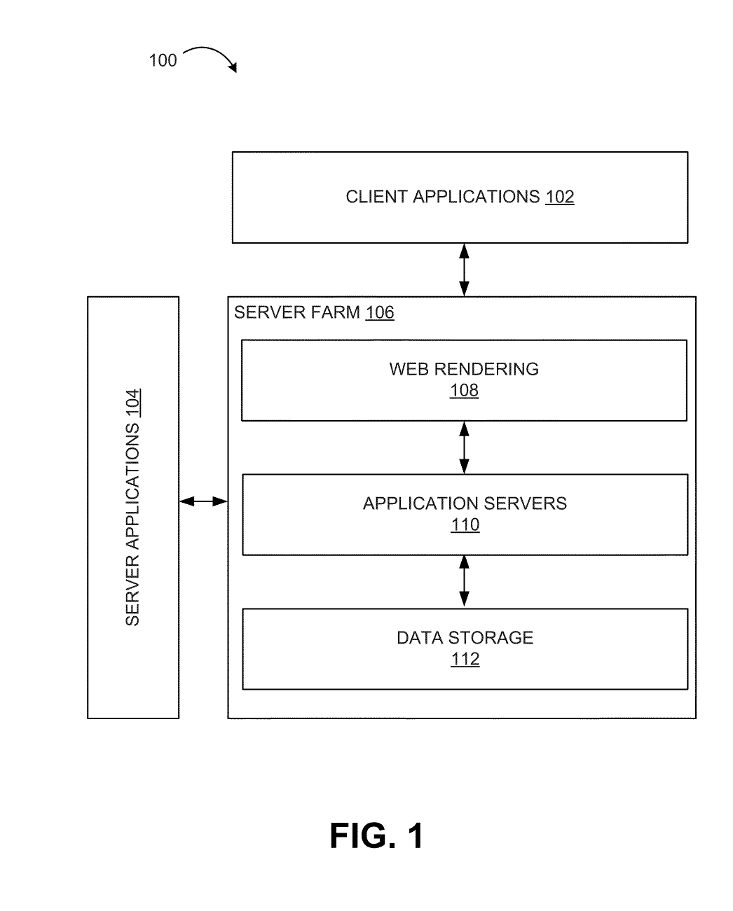

FIG. 1 illustrates an example topology for a hosted service.

A hosted service as shown in diagram 100 may provide a variety of services through one or more applications executed on servers (e.g., application servers 110) of a server farm 106. The services may include, but are not limited to desktop services, collaboration services, word processing, presentation, business data processing, graphics, and similar ones. In an example system, users may access the hosted service(s) through thin or thick client applications 102 executed on their client devices. For example, a browser executed on a client device may access a collaboration service executed on an application server and provide the user interface for the user to take advantage of the service's capabilities. In another example, a locally installed thick client (a client application with specific, dedicated capabilities) may access the hosted service to provide additional services or coordinate activities with other users, hosting entity, etc. Data associated with the hosted service may be stored on data storage 112 within the server farm.

In some cases, different servers of the server farm 106 may take on different roles. For example, some servers may manage data storage (e.g., database servers), other servers may execute the applications, and yet other servers may enable interaction of the client applications 102 with the application servers 110 (e.g., web rendering or front end servers 108).

In a further scenario, the hosted applications executed on the application servers 110 may be developed, tested, and maintained on separate servers and provided to the application servers 110. Upgrades, patches, and other changes to these server applications 104 may be provided the application servers 110 periodically or at random intervals. When a hosted service serves a large number of users (e.g., in hundreds of thousands), a relatively large number of servers may be involved in providing that service and the servers may be categorized in different environments. For example, a development and/or test environment, an internal production environment (for exclusive use of the members of the entity providing the service), and an external production environment (all users). Other examples of environments may include, but are not limited to, geographically segregated environments, environments separated based on service levels, and so on.

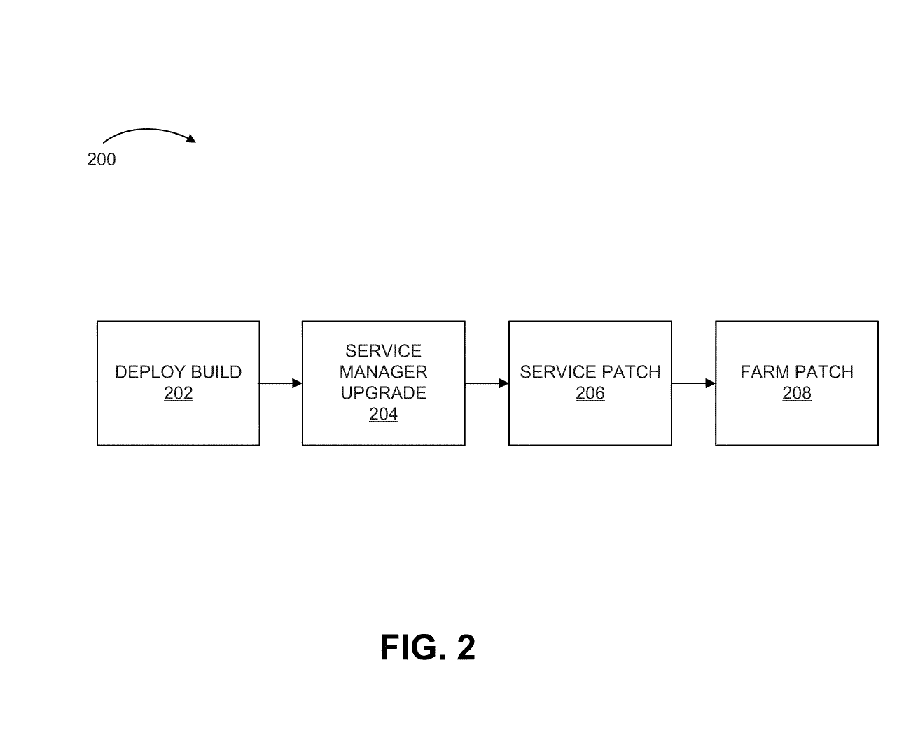

FIG. 2 illustrates example processes to deploy a build across environments.

Build deployment to different environments is performed sequentially as a patch train in conventional systems. As shown in diagram 200, a deploy build 202 may be followed by a service manager upgrade 204, followed by a service patch 206, and by farm patch 208. The main patch steps may not have hard dependency on each other, but the steps are typically coordinated manually. For example, text environment performance may have to be confirmed and the next level of deployment initiated manually. This strictly sequential and manual process may result in vulnerability to human errors, as well as reduced efficiency due to delays in deployment to different environments.

In a system according to embodiments, the patch steps may be decoupled and each step executed independently as long as its prerequisites are satisfied. Such a system may follow a central architecture or a distributed architecture. In yet other embodiments, a combination of central and distributed architectures may be employed.

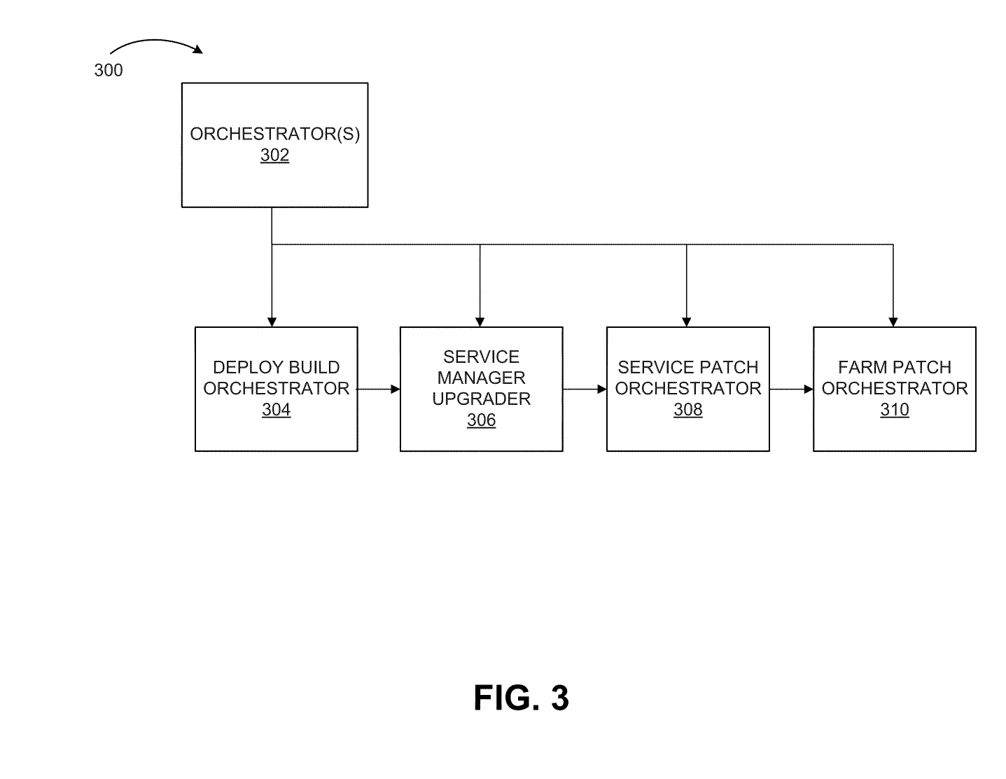

FIG. 3 illustrates example processes to deploy a build across environments managed by an orchestrator.

Diagram 300 shows an example architecture, where one or more orchestrators 302 may coordinate decoupled build deployment steps such that they can be executed independently while ensuring each step's perquisites are met. A central architecture system may have one orchestrator coordinating the build deployment activities for all environments. A distributed architecture may have multiple orchestrators, where each orchestrator may be responsible for one (or more) environment(s). In hybrid systems, a central orchestrator may coordinate information sharing among different orchestrators, each of which may be responsible for individual deployment environments.

In an example system depicted in diagram 300, the orchestrator 302 may create jobs corresponding to activities associated with each deployment step and coordinate initiation of the sub-orchestrator jobs.

For example, a deploy build orchestrator 304 may publish the build to the different zone and network shares using corresponding zone shares as a source. The service manager upgrader 306 may determine whether a deploy build activity is completed in the current environment, check prerequisites (e.g., whether the previous environment has completed service manager upgrade), and start its own service manager upgrade. The service patch orchestrator 308 may determine whether a deploy build activity is completed in the current environment, check prerequisites (e.g., whether the previous environment has completed service patch), and start its own service patching. The farm patch orchestrator 310 may determine whether a deploy build activity is completed in the current environment, check prerequisites (e.g., whether the previous environment has completed farm patch), and start its own farm patching in one or more phases.

A system according to embodiments may use tables that reside outside the scope of any one environment, but that is accessible by the environments. The tables may define the activities that are pending or running in the system, as well as the dependency chains that prevent activities from happening out of safe order (for example, a deployment happening on paying customers before happening in test environments). When a new build is available for deployment, the orchestrator may detect available build within brief period (e.g., minutes) and list new activities for the new build as pending in different environments. Any activities without prerequisite dependencies may start immediately, while those with prerequisites may wait for the prerequisites to be completed. Thus, dependencies may be encoded between activities and across environments in a way that can be accessed from any environment.

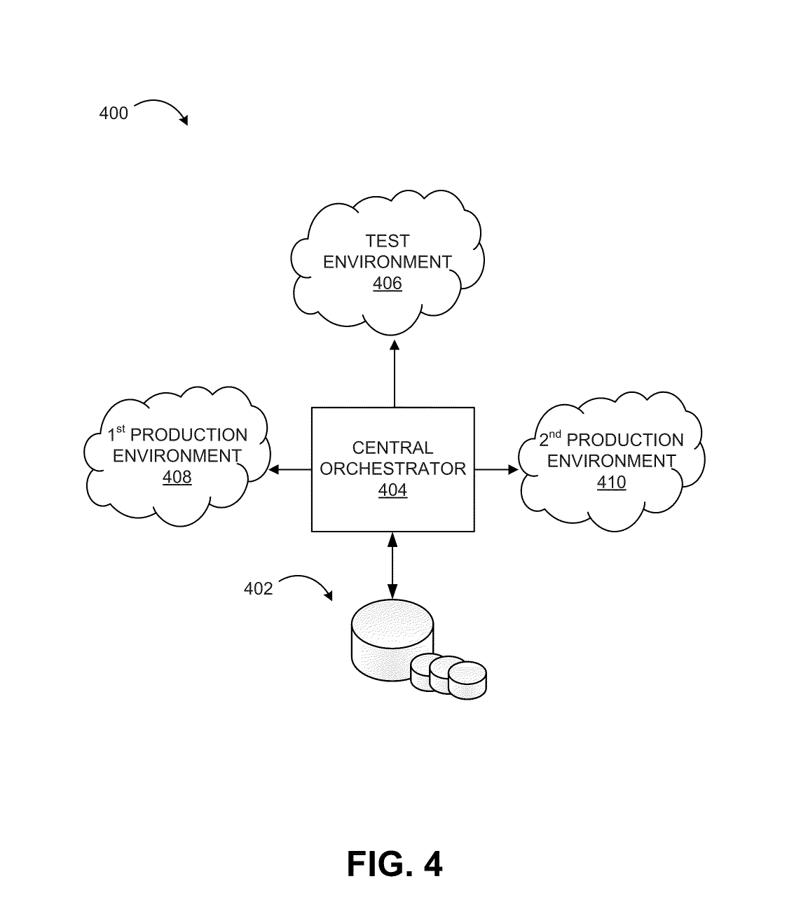

FIG. 4 illustrates a multi-environment hosted service system, where deployment of builds may be managed by a central orchestrator.

In the example central architecture system of diagram 400, central orchestrator 404 may detect availability of a new build in shared data stores 402, determine dependencies for deployment activities in environments 406, 408, and 410, and create/manage execution of the activities based on the determined dependencies. Thus, sequential execution through manual supervision may be eliminated in this centrally automated approach.

According to some embodiments, a hash based on the folders and files under a build folder may be computed at build time. The hash may include the folder and file names, creation dates, and sizes. The hash may be used by a deploy build job to validate whether a module which runs the job can view the folders and files. The orchestrator 404 may detect the available build when it is saved in the shared data storage 402 and perform following activities: add the new build into a builds table and set the build type (e.g., official, test version, etc.) accordingly; parse a patch definition file and update patch activity definitions (in a table) accordingly; add new records into a patch activities table for the new build; and start sub-orchestrator jobs accordingly.

The shared data storage 402 may also store states of different environments in regard to the deployment of the new build in each environment. Especially in cases, where deployment dependencies involve cross-environment issues (e.g., deployment in production environment may depend on successful completion of deployment in test environment), the orchestrator 404 may update and check those states to ensure the dependency chains are followed.

At any point during the deployment, the build train may be stopped. For example, if an issue is discovered during execution of one of the sub-orchestrator jobs (in an environment that may affect the other environments), the entire deployment may be halted, states of the different environments recorded, and the train re-started upon resolution of the issue observing the dependency chains.

In large and/or complex service environments, patches may be deployed frequently (e.g., daily or multiple times a day). In some scenarios, a patch for one or more environments may be delayed while other patches arrive for deployment. As long as dependency chains and prerequisites are observed, multiple build trains may be released on different environments. In other scenarios, a private release (PR) package may be built to target a specific product component (e.g., in case of emergency patch). Such a patch train may target one or several farms at the destination environment.

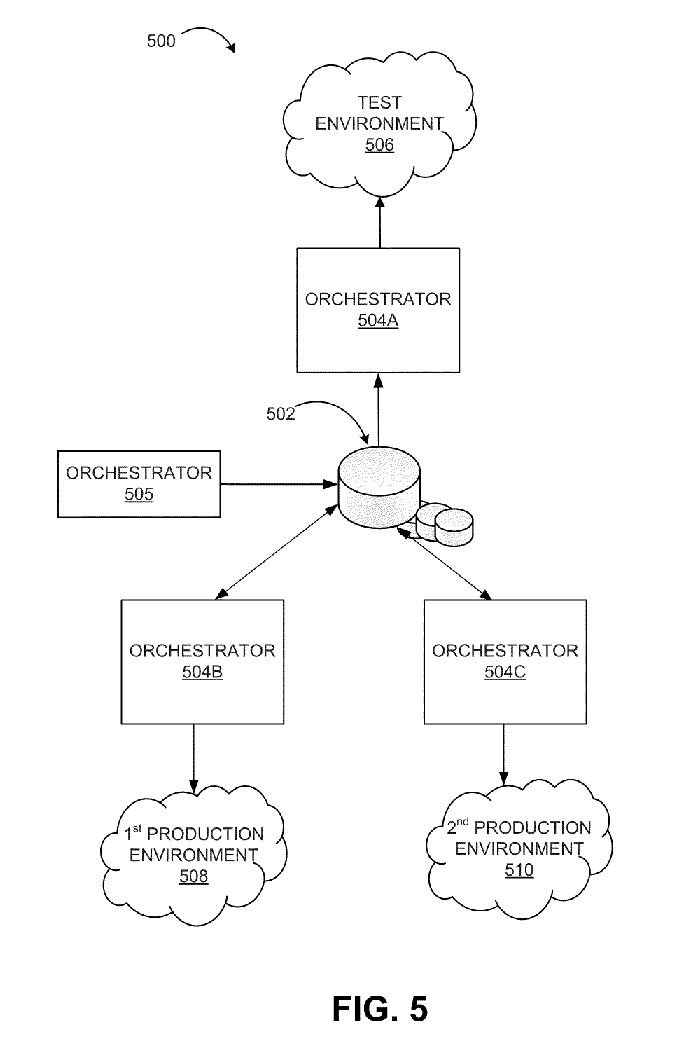

FIG. 5 illustrates another multi-environment hosted service system, where deployment of builds may be managed by distributed orchestrators whose activities are coordinated by a central orchestrator.

Diagram 500 shows a hybrid architecture system, where build deployments to individual example environments 506, 508, and 510 are managed by corresponding orchestrators 504A, 504B, and 504C. All orchestrators may have access to shared data storage 502, where the build(s) to be deployed, activity tables with dependency chain definitions, prerequisite definitions, and deployment states may be stored. A central orchestrator 505 may supervise the detection of the new build for all environments, create the activity tables, and/or communicate with the individual environment orchestrators to notify them about the new build. The individual orchestrators may update the states of deployment in their respective environments at the shared data storage.

In some embodiments, the central orchestrator's role may be more limited with the individual orchestrators being more active in detecting available builds at the shared data storage, update states of their respective environments, etc.

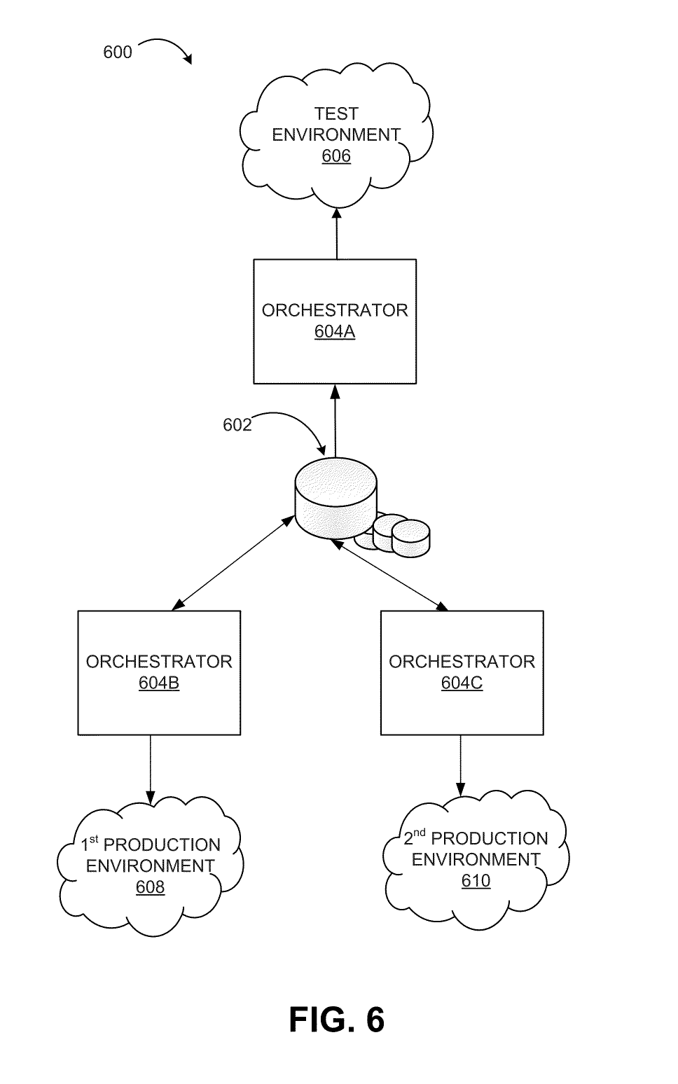

FIG. 6 illustrates a further multi-environment hosted service system, where deployment of builds may be managed by distributed orchestrators.

Diagram 600 shows a completely distributed system, where orchestrators 604A, 604B, and 604C manage deployment of builds to their respective environments 606, 608, and 610. All orchestrators may have access to shared data storage 602 and detect availability of a new build from there. The orchestrators may use the same activity tables with activity and dependency definitions to determine their respective activities, check on prerequisite completions, and update states of their respective environments.

The examples in FIG. 1 through 6 have been described with specific systems including specific apparatuses, components, component configurations, and component tasks. Implementations are not limited to systems according to these example configurations. Deployment of builds of upgrade, patches, and the like through orchestration using tables that reside outside the scope of any one environment may be implemented in configurations using other types of systems including specific apparatuses, components, component configurations, and component tasks in a similar manner using the principles described herein.

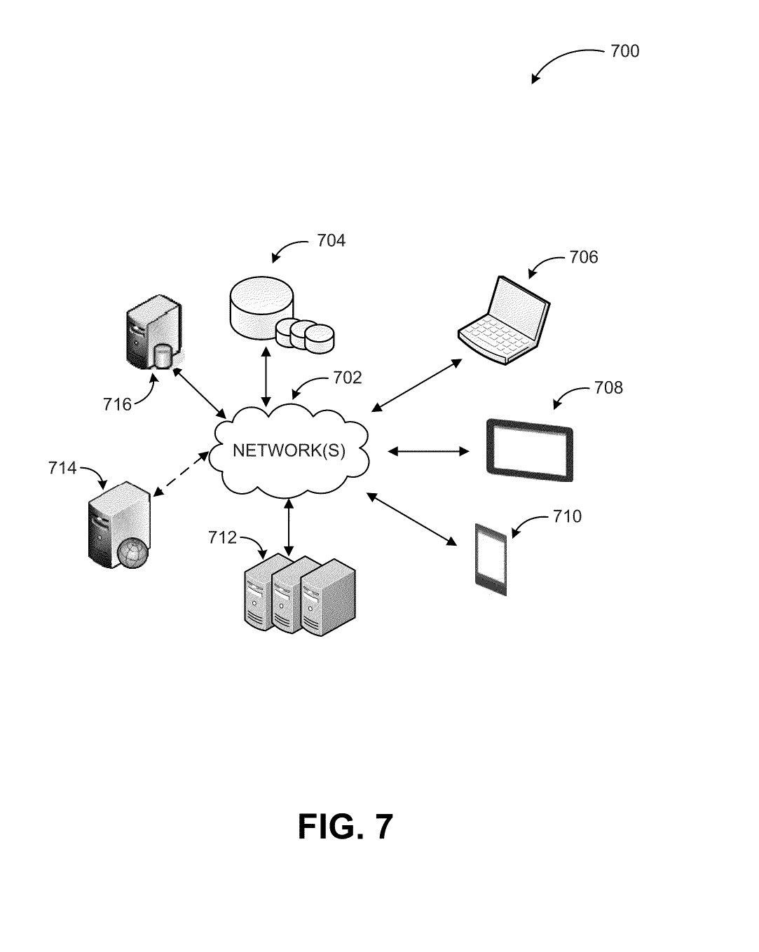

FIG. 7 is a networked environment, where a system according to embodiments may be implemented.

A system to provide orchestration of cross-environment deployment of build activities may be implemented via software executed over one or more servers 712 such as a hosted service. The platform may communicate with client applications on individual computing devices such as a smart phone 710, a tablet computer 708, a laptop computer 706, or desktop computer (‘client devices’) through network(s) 702.

Client applications executed on any of the client devices 706-710 may facilitate communications via application(s) executed by servers 712, or on individual server 714. An orchestrator application executed on one of the servers may include a deployment module. The orchestrator application and/or the deployment module may be configured to orchestrate deployment of builds of upgrade, patches, and the like using tables that reside outside the scope of any one environment, but that is accessible by the environments. The tables may define the activities that are pending or running in the system, as well as the dependency chains that prevent activities happening out of safe order. The orchestrator application may retrieve relevant data from data store(s) 704 directly or through database server 716, and provide requested services to the user(s) through client devices 706-710.

Network(s) 702 may comprise any topology of servers, clients, Internet service providers, and communication media. A system according to implementations may have a static or dynamic topology. Network(s) 702 may include secure networks such as an enterprise network, an unsecure network such as a wireless open network, or the Internet. Network(s) 702 may also coordinate communication over other networks such as Public Switched Telephone Network (PSTN) or cellular networks. Furthermore, network(s) 702 may include short range wireless networks such as Bluetooth or similar ones. Network(s) 702 provide communication between the nodes described herein. By way of example, and not limitation, network(s) 702 may include wireless media such as acoustic, RF, infrared and other wireless media.

Many other configurations of computing devices, applications, display systems, data sources, and data distribution systems may be employed to implement cross-environment orchestration of deployment activities. Furthermore, the networked environments discussed in FIG. 7 are for illustration purposes only. Implementations are not limited to the example applications, modules, or processes.

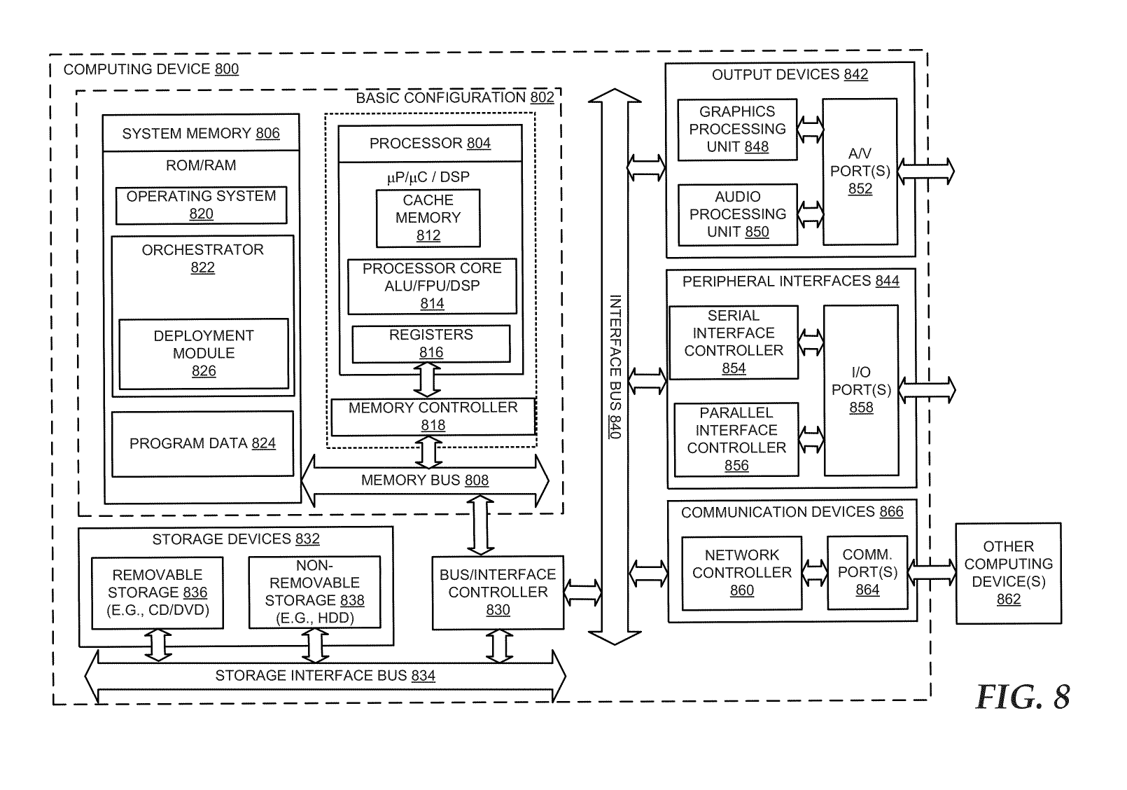

FIG. 8 and the associated discussion are intended to provide a brief, general description of a suitable computing environment in which implementations may be used.

For example, the computing device 800 may be used in conjunction with a build deployment system of a hosted service (e.g., as a server). In an example of a basic configuration 802, the computing device 800 may include one or more processors 804 and a system memory 806. A memory bus 808 may be used for communication between the processor 804 and the system memory 806. The basic configuration 802 may be illustrated in FIG. 8 by those components within the inner dashed line.

Depending on the desired configuration, the processor 804 may be of any type, including, but not limited to, a microprocessor (μP), a microcontroller (μC), a digital signal processor (DSP), or any combination thereof The processor 804 may include one more levels of caching, such as a level cache memory 812, a processor core 814, and registers 816. The processor core 814 may include an arithmetic logic unit (ALU), a floating point unit (FPU), a digital signal processing core (DSP Core), or any combination thereof A memory controller 818 may also be used with the processor 804, or in some implementations, the memory controller 818 may be an internal part of the processor 804.

Depending on the desired configuration, the system memory 806 may be of any type including but not limited to volatile memory (such as RAM), non-volatile memory (such as ROM, flash memory, etc.), or any combination thereof The system memory 806 may include an operating system 820 suitable for controlling the operation of the platform, such as the WINDOWS®, WINDOWS MOBILE®, WINDOWS RT®, or WINDOWS PHONE®, and similar operating systems from MICROSOFT CORPORATION of Redmond, Wash. The system memory 806 may further include an orchestrator application or module 822, a deployment module 826, and a program data 824. The orchestrator application or module 822 and the deployment module 826, in combination or individually, may detect that a new build is available for deployment and list new activities for that build in tables as pending in the affected environments. Any activities having no prerequisite dependencies may start immediately, while those with prerequisites may wait for the prerequisite activities to be completed.

The computing device 800 may have additional features or functionality, and additional interfaces to facilitate communications between the basic configuration 802 and any desired devices and interfaces. For example, a bus/interface controller 830 may be used to facilitate communications between the basic configuration 802 and one or more data storage devices 832 via a storage interface bus 834. The data storage devices 832 may be one or more removable storage devices 836, one or more non-removable storage devices 838, or a combination thereof Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 806, the removable storage devices 836, and the non-removable storage devices 838 may be examples of computer storage media. Computer storage media may include, but may not be limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 800. Any such computer storage media may be part of the computing device 800.

The computing device 800 may also include an interface bus 840 for facilitating communication from various interface devices (for example, one or more output devices 842, one or more peripheral interfaces 844, and one or more communication devices 866) to the basic configuration 802 via the bus/interface controller 830. Some of the example output devices 842 may include a graphics processing unit 848 and an audio processing unit 850, which may be configured to communicate to various external devices, such as a display or speakers via one or more AN ports 852. One or more example peripheral interfaces 844 may include a serial interface controller 854 or a parallel interface controller 856, which may be configured to communicate with external devices, such as input devices (for example, keyboard, mouse, pen, voice input device, touch input device, etc.) or other peripheral devices (for example, printer, scanner, etc.) via one or more I/O ports 858. An example communication device 866 may include a network controller 860, which may be arranged to facilitate communications with one or more other computing devices 862 over a network communication link via one or more communication ports 864. The one or more other computing devices 862 may include servers, client equipment, and comparable devices.

The network communication link may be one example of a communication media. Communication media may be embodied by computer-readable instructions, data structures, program modules, or other data in a modulated data signal, such as a carrier wave or other transport mechanism, and may include any information delivery media. A “modulated data signal” may be a signal that has one or more of the modulated data signal characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer-readable media, as used herein, may include both storage media and communication media.

The computing device 800 may be implemented as a part of a general purpose or specialized server, mainframe, or similar computer, which includes any of the above functions. The computing device 800 may also be implemented as a personal computer including both laptop computer and non-laptop computer configurations.

Example implementations also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

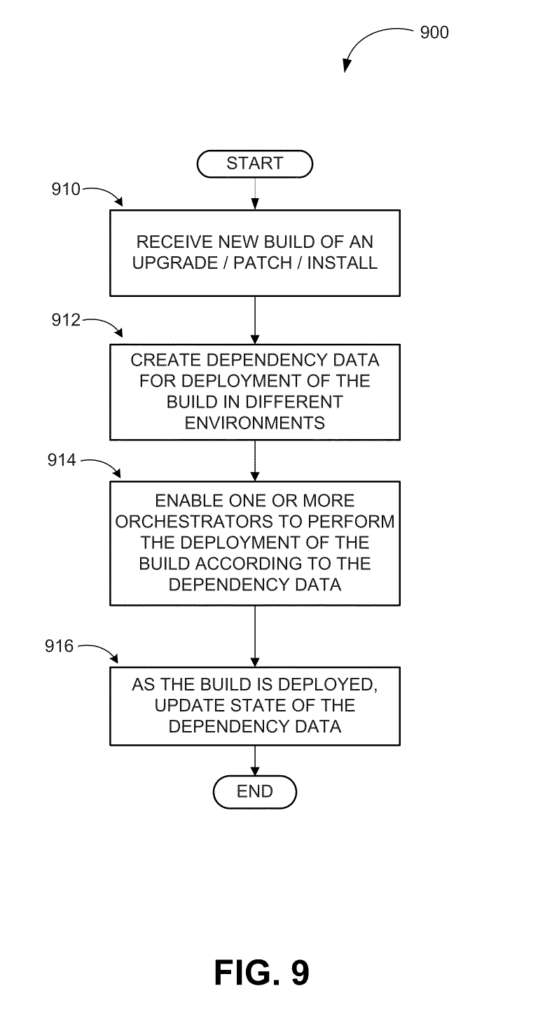

FIG. 9 illustrates a logic flow diagram for a process of deploying a build across environments, according to embodiments. Process 900 may be implemented on a server associated with application deployment and maintenance, for example.

Process 900 may begin with operation 910, where a new build of an upgrade, patch, or new install may be received or detected. At operation 912, dependency data (tables) may be created for deployment of the build in different environments. In some examples, an activity table may be generated for each environment. In other examples, a central table may define activities associated with the deployment of the new build across different environments.

At operation 914 following operation 912, one or more orchestrators (depending on whether a central orchestrator system is used or a distributed orchestrator system is used) may be enabled to perform the deployment of the build across the different environments according to the definitions of dependency chains and other information stored in the table(s). At optional operation 916, the state of the dependency data in the table(s) may be updated as the build is being deployed so that the orchestrator(s) can follow the activities as defined.

The operations included in process 900 are for illustration purposes. Cross-environment orchestration of deployment activities may be implemented by similar processes with fewer or additional steps, as well as in different order of operations using the principles described herein.

According to some examples, a method to automate a flow of deployment activities across environments is described. An example method may include detecting receipt of a build from an external data source to a data store coupled to one or more servers; generating one or more dependency chains for deploying the received build to one or more environments; and utilizing one or more orchestrators executed at the one or more servers to perform the deployment activities in the one or more environments according to the one or more dependency chains.

According to other examples, the method may also include defining the deployment activities based on a build type, an environment type, and one or more dependencies associated with each activity. The method may further include defining the deployment activities and the dependency chains in one or more tables stored at the data store, where the date store is accessible by the one or more environments. The method may also include storing a deployment state of each environment in the one or more tables; and performing the deployment activities according to a stored deployment state of each environment.

According to further examples, the method may include employing a central orchestrator to detect the receipt of the build, to generate the dependency chains, to define the deployment activities, to store deployment states of the environments, and to perform the deployment activities. The method may also include employing individual orchestrators corresponding to each environment to detect the receipt of the build, to generate the dependency chains, to define the deployment activities, to store deployment states of the environments, and to perform the deployment activities, wherein the individual orchestrators have access to the data store. The method may further include enabling the individual orchestrators to use a same table to define the deployment activities, to store the deployment states of the respective environments, and to check the deployment states of other environments.

According to yet other examples, the method may include employing a central orchestrator to detect the receipt of the build, to generate the dependency chains, and to define the deployment activities; and employing individual orchestrators corresponding to each environment to store deployment states of the environments, to check the deployment states of other environments, and to perform the deployment activities, where the individual orchestrators have access to the data store. The method may also include using a hash to validate whether a module that executes a deployment job is able to view folders and files associated with the build, where the hash is computed based on the folders and files at build time and includes folder and file names, creation dates, and sizes. The method may further include upon discovery of an issue with deployment in one of the environments, halting the deployment of the build to all environments; and upon resolution of the issue, restarting the deployment of the build based on deployment states of the environments at the data store. The one or more environments may include a development environment, a test environment, an internal production environment, and an external production environment.

According to other examples, a system for automating a flow of deployment activities across environments is described. The system may include a data store accessible by one or more environments configured to receive a build and a server configured to execute an orchestrator. The orchestrator may detect receipt of the build from an external data source; generate one or more dependency chains for deploying the received build to the one or more environments; and enable performance of the deployment activities in the one or more environments according to the one or more dependency chains, where the deployment activities are defined in one or more tables stored at the data store based on a build type, an environment type, and one or more dependencies associated with each activity.

According to some examples, the orchestrator may also store deployment states of the environments; and initiate the deployment activities. The orchestrator may further enable individual orchestrators corresponding to each environment to detect the receipt of the build, to store deployment states of the environments, and to perform the deployment activities in the corresponding environments, where the individual orchestrators use the one or more tables to store deployment states of their corresponding environments and to check the deployment states of other environments.

According to yet other examples, the orchestrator may manage deployment of multiple builds concurrently adhering to the dependency chains and observing potential conflicts among the builds. The orchestrator may also manage deployment of a private release (PR) package arranged to target a specific hosted application; and manage deployment of a patch arranged to target one or more server farms at a destination environment.

According to further examples, a computer-readable memory device with instructions stored thereon for automating a flow of deployment activities across environments is described. the instructions may include detecting receipt of a build from an external data source to a data store coupled to one or more servers; generating one or more dependency chains for deploying the received build to one or more environments; storing a deployment state of each environment in one or more tables at the data store, where the deployment activities are defined in the one or more tables based on a build type, an environment type, and one or more dependencies associated with each activity; and utilizing one or more orchestrators executed at the one or more servers to perform the deployment activities in the one or more environments according to the one or more dependency chains.

According to other examples, the one or more orchestrators may include a deploy build orchestrator configured to publish the build to different zone and network shares using corresponding zone shares as a source; a service manager upgrader configured to determine whether a deployment activity is completed in a current environment associated with the service manager upgrader, check prerequisites, and start a service manager upgrade in the current environment associated with the service manager upgrader; a service patch orchestrator configured to determine whether a deployment activity is completed in a current environment associated with the service patch orchestrator, check prerequisites, and start a service patching in the current environment associated with the service patch orchestrator; and a farm patch orchestrator configured to determine whether a deployment activity is completed in a current environment associated with the farm patch orchestrator, check prerequisites, and start farm patching in the current environment associated with the farm patch orchestrator in one or more phases. The one or more environments may include a development environment, a test environment, an internal production environment, an external production environment, one or more geographically separated environments, and one or more environments separated based on customer service levels.

The above specification, examples and data provide a complete description of the manufacture and use of the composition of the implementations. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and implementations.

The foregoing detailed description has set forth various implementations of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples may be implemented, individually and/or collectively, by a wide range of hardware, software, firmware, or virtually any combination thereof, as understood by a person having ordinary skill in the art. In one example, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the implementations disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of the disclosure.

1. A method to automate a flow of deployment activities across one or more environments, the method comprising:
detecting receipt of a build from an external data source to a data store coupled to one or more servers;
storing deployment states of each of the one or more environments in one or more tables, wherein the one of more tables are stored at the data store;
generating one or more dependency chains for deploying the received build to the one or more environments;
upon deployment of the build, updating the deployment states in the one or more tables; and
utilizing one or more orchestrators executed at the one or more servers to perform the deployment activities in the one or more environments according to the deployment states and the one more dependency chains.

2. The method of claim 1, further comprising:
defining the deployment activities based on a build type, an environment type, and one or more dependencies associated with each activity.

3. The method of claim 2, further comprising:
defining the deployment activities and the dependency chains in one or more tables stored at the data store, wherein the data store is accessible by the one or more environments.

4. The method of claim 1, further comprising:
performing the deployment activities according to the stored deployment states of each of the one or more environments.

5. The method of claim 1, further comprising:
employing a central orchestrator to detect the receipt of the build, to generate the dependency chains, to define the deployment activities, to store the deployment states of the one or more environments, and to perform the deployment activities.

6. The method of claim 1, further comprising:
employing individual orchestrators corresponding to each of the one or more environments to detect the receipt of the build, to generate the dependency chains, to define the deployment activities, to store the deployment states of the one or more environments, and to perform the deployment activities, wherein the individual orchestrators have access to the data store.

7. The method of claim 6, further comprising:
enabling the individual orchestrators to use a same table to define the deployment activities, to store the deployment states of the one or more environments, and to check the deployment states of other environments.

8. The method of claim 1, further comprising:
employing a central orchestrator to detect the receipt of the build, to generate the dependency chains, and to define the deployment activities; and
employing individual orchestrators corresponding to each of the one or more environments to store the deployment states of the one or more environments, to check the deployment states of other environments, and to perform the deployment activities, wherein the individual orchestrators have access to the data store.

9. The method of claim 1, further comprising:
using a hash to validate whether a module that executes a deployment job is able to view folders and files associated with the build, wherein the hash is computed based on the folders and files at build time and includes folder and file names, creation dates, and sizes.

10. The method of claim 1, further comprising:
upon discovery of an issue with deployment in one of the one or more environments, halting the deployment of the build to all environments; and
upon resolution of the issue, restarting the deployment of the build based on the deployment states of the one or more environments at the data store.

11. The method of claim 1, wherein the one or more environments include a development environment, a test environment an internal production environment, and an external production environment.

12. A system for automating a flow of deployment activities across one or more environments, the system comprising:
a data store accessible by the one or more environments configured to receive a build;
a server configured to execute an orchestrator, wherein the orchestrator is configured to:
detect receipt of the build from an external data source;
store deployment states of each of the one or more environments in one or more tables;
generate one or more dependency chains for deploying the received build to the one Or more environments;
upon deployment of the build, update the deployment states in the one or more tables; and
enable performance of the deployment activities in the one or more environments according to the deployment states and the one or more dependency chains, wherein the deployment activities are defined in the one or more tables stored at the data store based on a build type, an environment type, and one or more dependencies associated with each activity.

13. The system of 12, wherein the orchestrator is further configured to:
initiate the deployment activities.

14. The system of claim 12, wherein the orchestrator is further configured to:
enable individual orchestrators corresponding to each of the one or more environments to detect the receipt of the build, to store the deployment, states of the one or more environments, and to perform the deployment activities in the corresponding environments, wherein the individual orchestrators use the one or more tables to store the deployment states of their corresponding environments and to check the deployment states of other environments.

15. The system of claim 12, wherein the orchestrator is further configured to:
manage deployment of multiple builds concurrently adhering to the dependency chains and observing potential conflicts among the builds.

16. The system of claim 12. Wherein the orchestrator is further configured to:
manage deployment of a private release (PR) package arranged to target a specific hosted application.

17. The system of claim 12. Wherein the orchestrator is further configured to:
manage deployment of a patch arranged to target one or more server farms at a destination environment.

18. A computer-readable memory device with instructions stored thereon for automating a flow of deployment activities across one or more environments, the instructions comprising:
detecting receipt of a build from an external data source to a data store coupled to one or more servers:
generating one or more dependency chains liar deploying the received build to the one or more environments;
storing deployment states of each of the one or more environments in one or more tables at the data store, wherein the deployment activities are defined in the one or more tables based on a build type, an environment type, and one or more dependencies associated with each activity;
upon deployment of the build, updating the deployment states in the one or more tables; and
utilizing one or more orchestrators executed at the one or more servers to perform the deployment activities in the one or more environments according to the devolvement states and the one or more dependency chains.

19. The computer-readable memory device of claim 18, wherein the one or more orchestrators include:
a deploy build orchestrator configured to publish the build to different zone and network shares using corresponding zone shares as a source;
a service manager upgrade configured to determine whether the deployment activities are completed in a current environment associated with the service manager upgrader, check prerequisites, and start a service manager upgrade in the current environment associated with the service manager upgrader;
a service patch orchestrator configured to determine whether the deployment activities are completed in the current environment associated with the service patch orchestrator, check prerequisites, and start a service patching in the current environment associated with the service patch orchestrator; and
a farm patch orchestrator configured to determine whether the deployment activities are completed in the current environment associated with the farm patch orchestrator, check prerequisites, and start farm patching in the current environment associated with the farm patch orchestrator in one or more phases.

20. The computer-readable memory device of claim 18, wherein the one or more environments include a development environment, a test environment, an internal production environment, an external production environment, one or more geographically separated environments, and one or more environments separated based an customer service levels.
